(19) United States
(12) Patent Application Publication
(10) Pub. No.: US 2013/0117672 A1
(43) Pub. Date: May 9, 2013

(54) METHODS AND SYSTEMS FOR GATHERING DATA RELATED TO A PRESENTATION AND FOR ASSIGNING TASKS

(71) Applicant: Wheelhouse Analytics, LLC, West Chester, PA (US)

(72) Inventor: FRANK COATES, West Chester, PA (US)

(73) Assignee: Wheelhouse Analytics, LLC, West Chester, PA (US)

(21) Appl. No.: 13/666,310

(22) Filed: Nov. 1, 2012

Related U.S. Application Data
(60) Provisional application No. 61/555,067, filed on Nov. 3, 2011.

(51) Int. Cl. G06F 3/01

(52) U.S. Cl. 715/730

(57) ABSTRACT

Methods and systems for gathering data related to a presentation and for generating tasks are disclosed. The presentation is given to an audience by a presenter using a display system. The display system includes a display portion, an input portion, a memory portion for storing the presentation, and one or more processors operable to control the information displayed on the display portion and the data stored in the memory portion. The method includes displaying one or more images on the display portion. The images include the information to be presented to the audience. The method further comprises receiving data that includes a report from the presenter on the performance of the presentation. The method further comprises storing the report in association with the presentation in the memory portion. Tasks may be generated by a user of an electronic system. The system may display aspects of a task on a display system. Icons corresponding to a first task aspect and icons corresponding to a second task aspect are displayed for selection by a user. Tasks are generated based on the icons selected by the user.

### CROSS REFERENCE TO RELATED APPLICATIONS

The present application is related to U.S. Provisional Application Ser. No. 61/555,067 entitled METHODS AND SYSTEMS FOR GATHERING DATA RELATED TO A PRESENTATION filed on Nov. 3, 2011, the contents of which are incorporated fully herein by reference.

### FIELD OF THE INVENTION

The present invention is directed to gathering data related to a presentation and to assigning tasks.

### BACKGROUND OF THE INVENTION

In recent years, electronic systems have become popular vehicles for the presentation of information and the tracking of tasks. Electronic systems provide a simple, portable, and easily customizable way for presenters to organize and present information to an audience of people and for users to keep track of tasks. Accordingly, applications have been developed to assist users in giving presentations and tracking tasks using electronic systems. However, conventional software applications may not utilize the full capability of these systems to assist the user. Thus, there remains a need for improved systems and methods that assist the user.

### SUMMARY OF THE INVENTION

Aspects of the present invention are directed to methods and systems for gathering data related to a presentation and for tracking tasks.

In accordance with one aspect of the present invention, a method for gathering data from a presenter is disclosed. The presenter is giving a presentation of information to an audience using a display system. The display system comprises a display portion, an input portion, a memory portion for storing the presentation, and one or more processors operable to control the information displayed on the display portion and the data stored in the memory portion. The method comprises the steps of displaying one or more images on the display portion. The images include the information to be presented to the audience. The method further comprises receiving data from a presenter via the input portion. The received data comprises a report from the presenter on the performance of the presentation. The method further comprises storing the report in association with the presentation in the memory portion.

In accordance with another aspect of the present invention, a method for generating tasks using an electronic system is disclosed. The electronic system includes a display portion, an input portion, a memory portion, and a processing portion. The processing portion is operable to control the information displayed on the display portion. The method comprises the steps of displaying on the display portion a first plurality of icons and a second plurality of icons. The first plurality of icons correspond to a first task aspect and the second plurality of icons correspond to a second task aspect. The method further comprises the steps of receiving, via the input portion, a first selection by a user of one of the first plurality of icons and a second selection by the user of one of the second plurality of icons. The processing portion generates a task based on the received user selections of the one of the first plurality of icons and the one of the second plurality of icons.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram illustrating an exemplary display system in accordance with aspects of the present invention;

FIG. 2 is a flow chart illustrating an exemplary method for giving a presentation of information to an audience in accordance with aspects of the present invention;

FIGS. 3A-3F are images illustrating exemplary displays for implementing the method of FIG. 2;

FIG. 4 is a block diagram illustrating a system for assigning tasks in accordance with aspects of the present invention;

FIG. 5 is a flow chart illustrating an exemplary method for selecting a task to be completed in accordance with aspects of the present invention; and

FIGS. 6A-6B are images illustrating exemplary displays for implementing the method of FIG. 5.

### DETAILED DESCRIPTION OF THE INVENTION

The exemplary methods described herein are usable in conjunction with electronic systems to present information to an audience and to track tasks. Some embodiments are particularly suitable to assist a user and/or a company affiliated with the user in tracking, storing, and analyzing information about a presentation as it is being given and/or shortly thereafter, and in following up with audience members after the presentation is given. Other embodiments are particularly suitable to generate tasks.

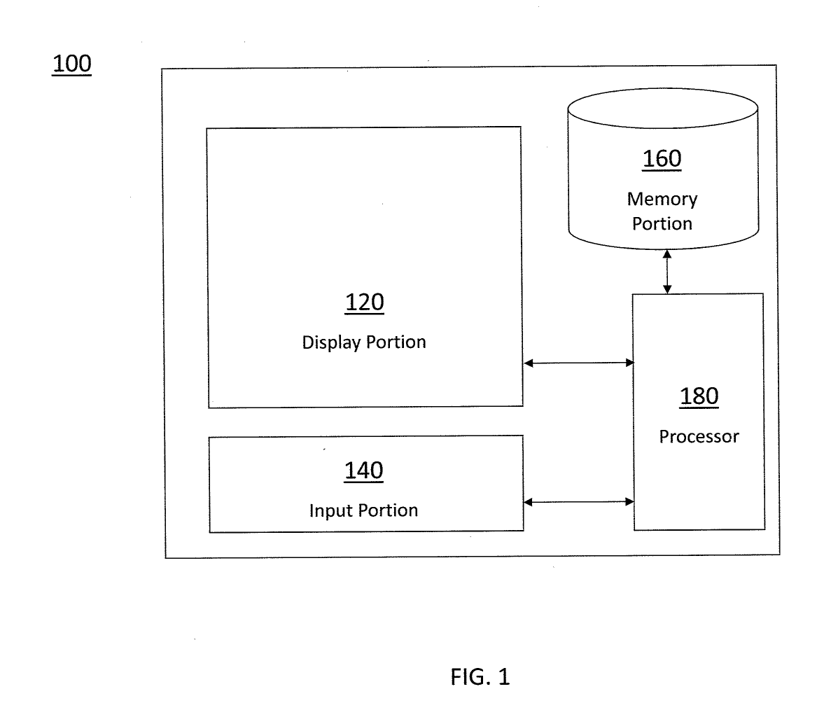

Referring now to the drawings, FIG. 1 illustrates an electronic display system 100 in accordance with aspects of the present invention. Display system 100 is usable to give a presentation of information to an audience. Display system 100 may be a portable electronic display system such as, for example, a tablet computer such as an iPad, available from Apple Inc. of Cupertino, Calif., USA; display system 100 may also be usable in conjunction with such devices. As a general overview, display system 100 includes a display portion 120, an input portion 140, a memory portion 160, and one or more processors 180. Additional details of display system 100 are described herein.

Display portion 120 presents information to the audience by display system 100. Display portion 120 is in communication with the other components of display system 100 via conventional wired or wireless connections. Display portion 120 may be connected to or physically separate from the rest of the components of display system 100, depending on the audience viewing of the presentation. In an exemplary embodiment, display portion 120 is an electronic display such as, for example, a liquid crystal display (LCD). Other suitable components for use as display portion 120, such as projectors, will be known to one of ordinary skill in the art from the description herein.

In one suitable embodiment, display portion 120 is integrally formed into a single device with the remaining components of display system 100, as shown in FIG. 1. In this embodiment, the presenter may use display portion 120 to give a presentation to a relatively small audience in a small group setting. This embodiment may be desirable for increasing the number of areas in which the presentation can be given, and improving the attention and connectedness of the audience to the presentation (i.e., by proximity).

In an alternative embodiment, display portion 120 may include multiple display screens. Display portion 120 may include a first display screen for viewing by a user (e.g., a display screen integrally formed with the other components of display system 100) and a second display screen for viewing by the audience. The second display screen may be another display system 100, or may be a larger screen, such as a projector screen. This embodiment may be desirable for relatively large audiences. The first and second display screens may be synchronized so that the user sees the same images being displayed to the audience. The first and second display screens are not limited to being in the same location. For example, the second display screen (viewed by the audience) may be at a location remote from the first display screen. In this way, display system 100 may be used to give a presentation to an audience that is remote from the user.

Input portion 140 enables the receipt of information from the user of display system 100. Input device 140 further transmits the received information to processor 180 for use in operating display system 100. In one embodiment, display portion 120 may comprise a touch screen (in addition to or in place of any other display components). In this embodiment, the touch screen may also be configured to function as input portion 140. In an alternative embodiment, input portion 140 may be a separate component configured to receive input from a user. For example, input portion 140 may be a keypad, mouse, button, or other conventional input device. Suitable components for use as input portion 140 will be known to one of ordinary skill in the art from the description herein.

Memory portion 160 stores data for display system 100. For example, memory portion 160 stores data comprising information to be presented with display system 100. Memory portion 160 may further store data comprising a presentation, which may include the information to be presented as well as an organization and layout of that information selected by the user. Suitable memory components for use as memory portion 160 will be known to one of ordinary skill in the art from the description herein.

Processor 180 controls the operation of display system 100. Processor 180 is operable to control the information displayed on display portion 120. Processor 180 is further operable to store and access data in memory portion 160. In particular, processor 180 is programmed to implement a method 1000 for giving a presentation of information to an audience using display system 100. Additional details of method 100 are set forth below.

It will be understood that display system 100 is not limited to the above components, but may include alternative components and additional components, as would be understood by one of ordinary skill in the art from the description herein. For example, processor 180 may include multiple processors, e.g., a first processor for controlling information displayed on display portion 120 and a second processor for controlling storage and access of data in memory portion 160.

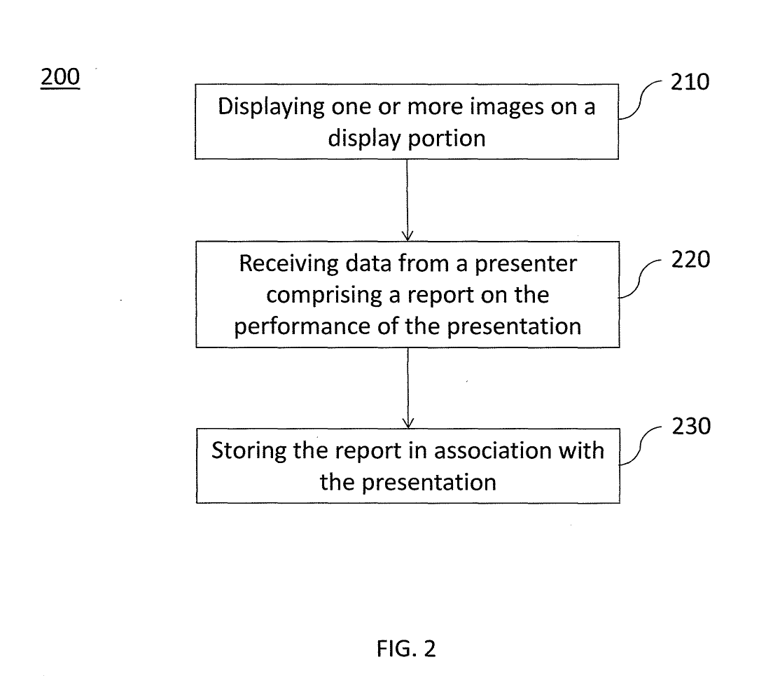

FIG. 2 shows an exemplary method 200 for giving a presentation of information to an audience in accordance with aspects of the present invention. Method 200 may desirably be implemented on a display system such as display system 100. As a general overview, method 200 includes displaying one or more images, receiving data from a presenter, and storing a report. Additional details of method 200 are described herein with respect to the components of display system 100.

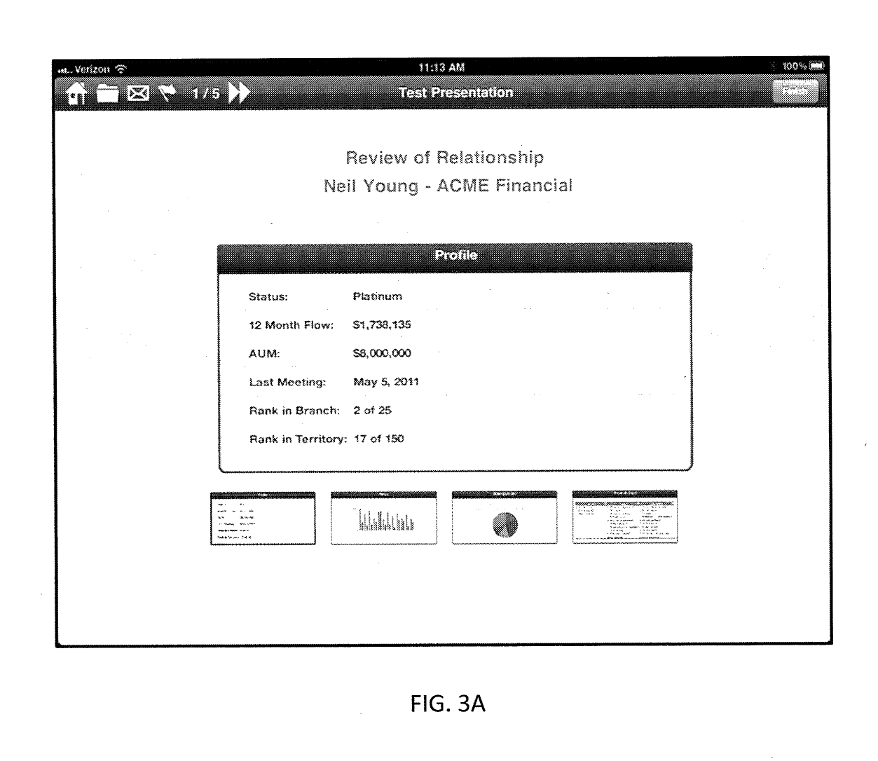

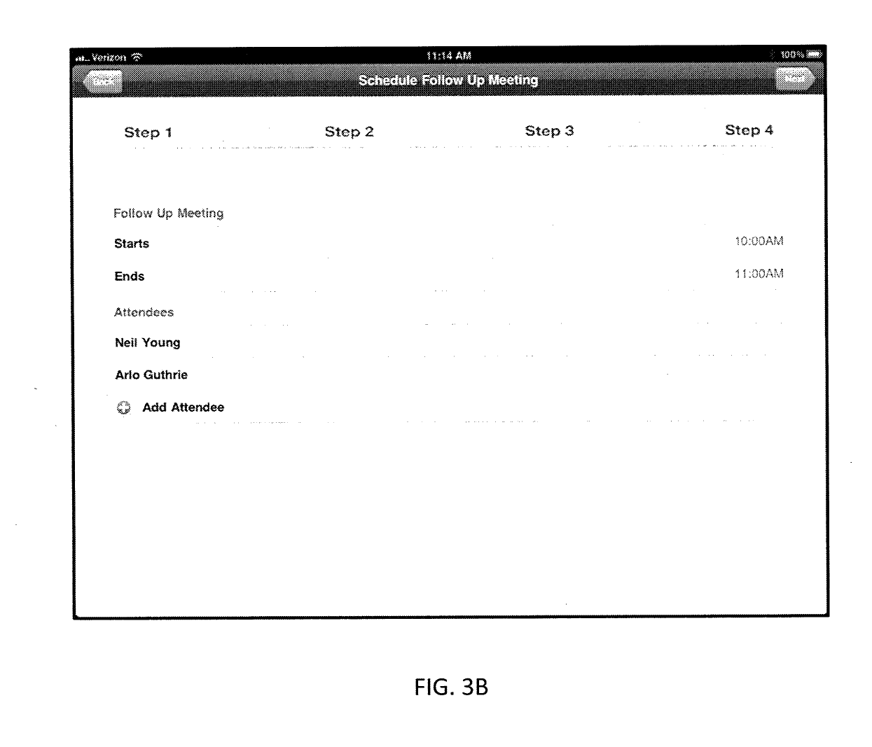

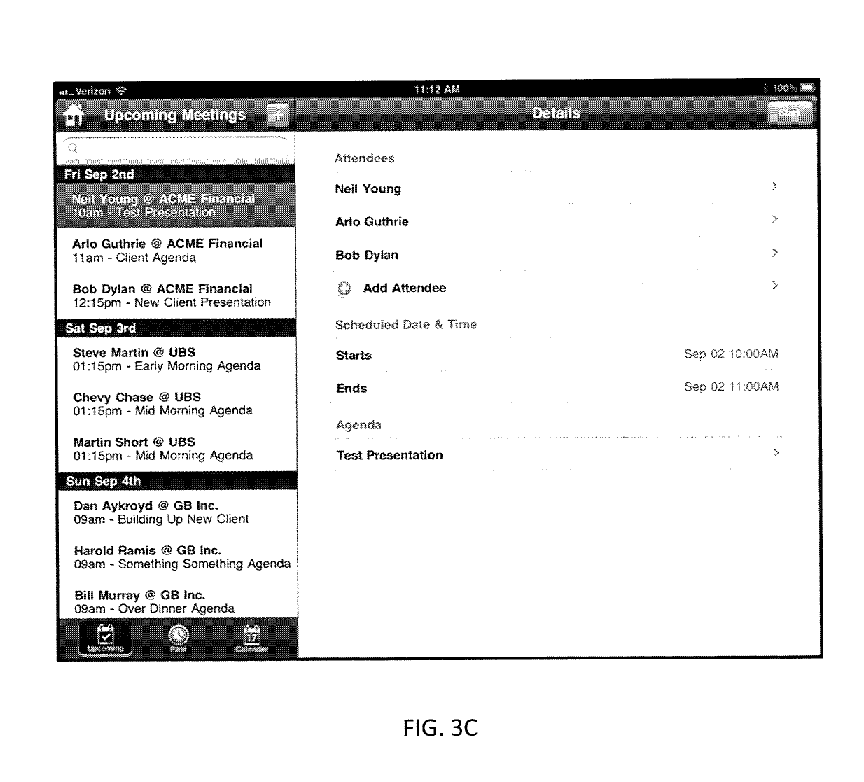

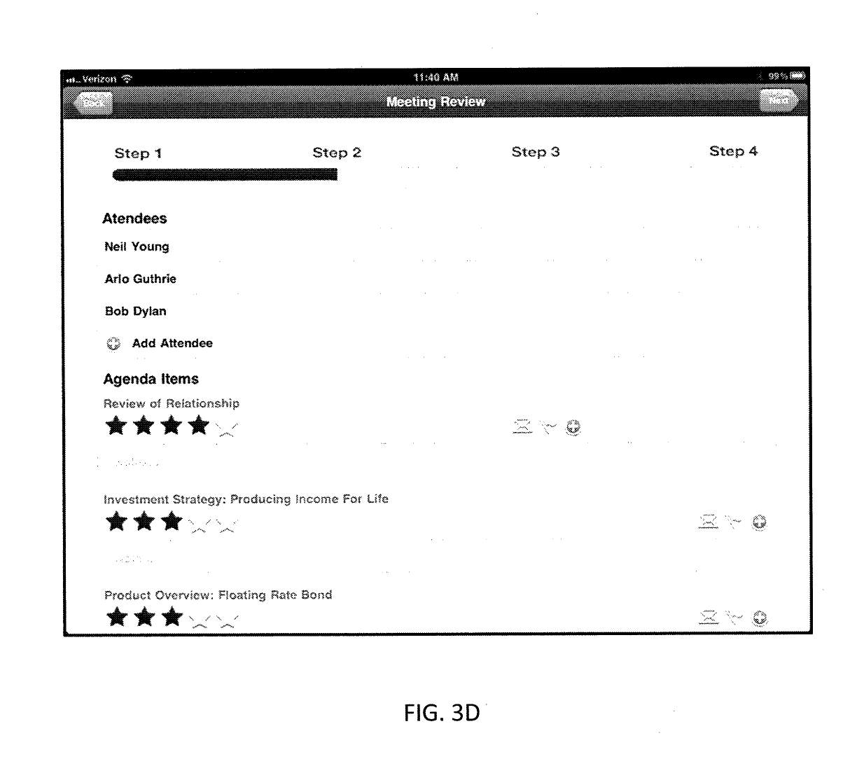

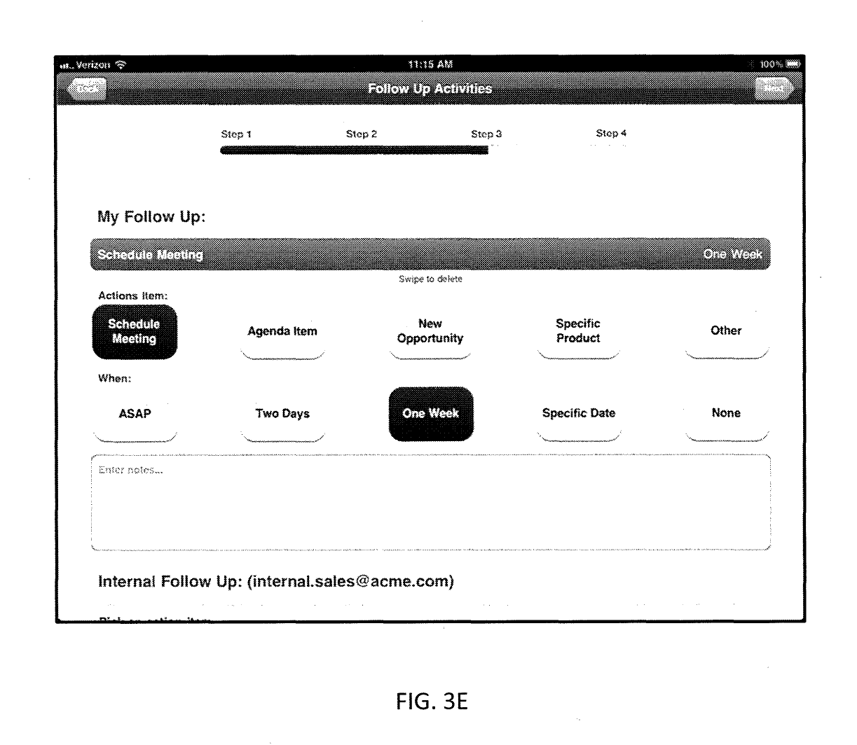

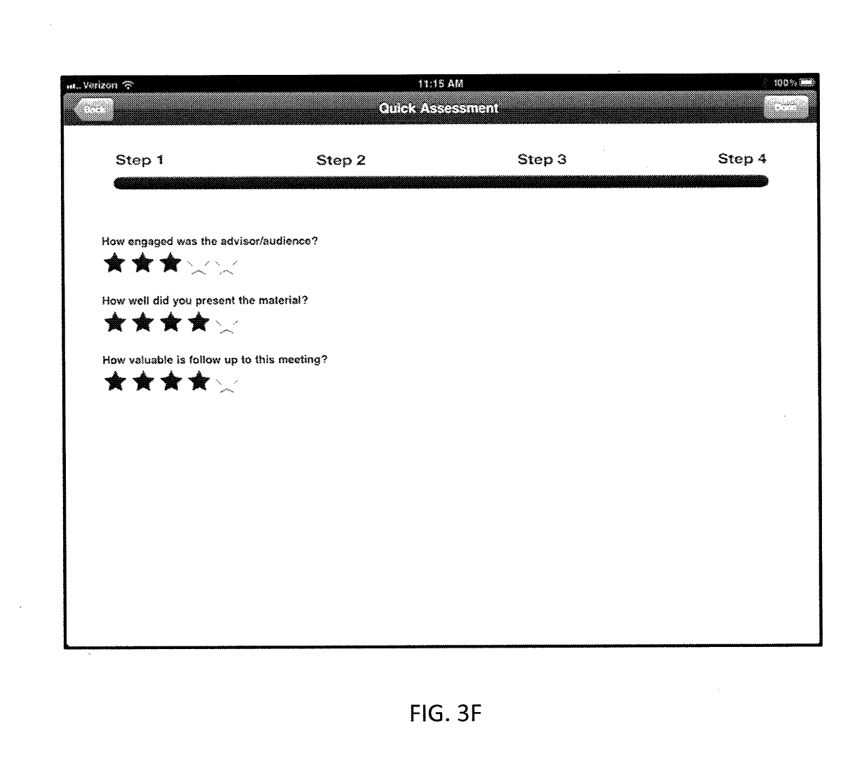

In step 210, one or more images are displayed. In an exemplary embodiment, processor 180 displays one or more images on display portion 120. The images comprise media (e.g., slides, video, audio, documents, websites, browsers, etc.) that include the information to be presented to the audience. For example, the images may comprise slides of the presentation. An exemplary slide is illustrated in FIG. 3A. The content and layout of each of the images may be selected in advance by the presenter during the creation of the presentation, as would be understood to one of ordinary skill in the art. Similarly, the number of images displayed may be selected in advance by the presenter based at least in part on the desired length of the presentation, and the quantity of information to be presented.

In step 220, data is received from a presenter. In an exemplary embodiment, the presenter uses input portion 140 to enter data into display system 100. The data comprises a report from the presenter on the performance of the presentation. Exemplary displays for prompting entry of the report are illustrated in FIGS. 3B-3F. The information in the report may be dependent on what information is presented during the presentation, or how (in the presenter's view) that information was presented or the audience reaction. The form and content of the report may take a number of forms, in accordance with aspects of the present invention, as described below.

In one exemplary embodiment, step 220 is performed during step 210, i.e., the data is received from the presenter during the presentation. For one example, the presenter may desire to note a portion of the presentation that went well or was well-received during the presentation. Thus, the report may comprise an indication by the presenter of a portion of the presentation in which the audience had an interest (i.e., the presenter may “flag” portions of the presentation).

Alternatively, a member of the audience may desire to note a portion of the presentation that they found particularly interesting. When the audience member is viewing the presentation using display system 100, the audience member may also be given the option to “flag” portions of the presentation as they are viewed. This information from audience members may be usable by the presenter in determining an agenda for a follow-up meeting.

In another exemplary embodiment, step 220 is performed after step 210, i.e., the data is received from the presenter following the presentation. In this embodiment, step 220 may comprise a plurality of sub-steps to be performed by the presenter following the presentation. FIG. 3B shows an exemplary display enumerating sub-steps to be performed by the presenter following the presentation. Exemplary sub-steps of step 220 will be described below.

In a first exemplary sub-step, the presenter may desire to memorialize details of the presentation such as the persons who attended the presentation and the date and time of the presentation. Thus, the report may comprise a record of the persons present in the audience for the presentation, and of the date and time of the presentation. FIG. 3C shows an exemplary display for prompting the entry of the above-described details of the presentation. This record may be useful to generate a mailing list of persons who attended the presentation, e.g., to forward them documents or files associated with the presentation.

In a second exemplary sub-step, the presenter may desire to rate how predetermined agenda items were received by the audience. For example, the presenter may have a number of agenda items that were intended to be discussed during the presentation. Thus, the report may comprise a rating of how those agenda items were received by the audience, including any relevant notes from the presenter. FIG. 3D shows an exemplary display for prompting the rating of agenda items. This information may be useful to ensure all important topics were properly addressed during the presentation, and identify any topics of particular interest that may be suitable for follow-up presentations.

In a third exemplary sub-step, the presenter may desire to follow-up with any members of the audience regarding one or more topics discussed during the presentation. Thus, the report may comprise a scheduled time for a follow-up meeting with one or more audience members. FIG. 3E shows an exemplary display for prompting the entry of a follow-up appointment. In a particularly preferred embodiment, when the scheduled time is entered into input portion 140, processor 180 enters the scheduled time in a virtual calendar of the presenter, so that the presenter will automatically be notified of the time and date of the follow-up meeting at a later time.

In a fourth exemplary sub-step, the presenter may desire to rate his or her connection with the audience during the presentation, including how engaged the audience was, how the material was presented, or the value of a follow-up meeting. Thus, the report may comprise a rating of one or more audience-specific aspects of the presentation. FIG. 3F shows an exemplary display for prompting the rating of aspects of the presentation. In addition to those aspects shown in FIG. 3F, such aspects may include, for example, audience reaction, audience questions, or the presenter's relationship with the audience.

It will be understood that the above-described exemplary sub-steps of step 220 are for the purposes of illustration. The order and content of each sub-step are presented as examples, and are not intended to be limiting. Alternative or additional sub-steps may be provided in method 200, as would be readily understood to one of ordinary skill in the art from the description herein.

In step 230, the report is stored in associated with the presentation. In an exemplary embodiment, processor 180 stores the report received from the presenter in memory portion 160. The report is stored in association with the presentation, such that the presenter may (at a later time) access the presentation and thereby review any reports that were entered in association with the presentation. This desirably gives the presenter with valuable feedback on the presentation, as well as possible action items in association with the presentation's audience.

It will be understood that method 200 is not limited to the above steps, but may include alternative steps and additional steps, as would be understood by one of ordinary skill in the art from the description herein.

For one example, it may be desirable that the duration of the presentation be stored in association with the presentation. Accordingly, method 200 may include the step of recording the length of time of at least a portion of the presentation, and storing the length of time in association with the presentation. In an exemplary embodiment, processor 180 may record the length of time, and store the recorded length of time in memory portion 160. Desirably, the recorded length of time may correspond to one of the one or more images displayed during the presentation. For example, processor 160 may record the length of time an individual slide (or each individual slide) is displayed during the presentation, in order to provide the presenter with an assessment of which slide or slides best held the audience's interest, or contained the most useful information. Similarly, processor 160 may record the length of time a separate document is accessed and/or presented during the presentation, in order to provide the presenter with an assessment of the document's usefulness. The length of time may be recorded, for example, by tracking the time between transitions in the presentation (e.g., noting the length of time one agenda item is displayed to the audience before transitioning to the next agenda item).

For another example, it may be desirable to analyze the data entered by the presenter in order to determine useful aspects of the presentation. Accordingly, method 200 may include the step of analyzing the report. In an exemplary embodiment, processor 180 analyzes the report in order to refine the content or order of content for future presentations. Processor 180 may analyze the report to identify the slide or slides of the presentation that are presented for the longest period of time during the presentation. Accordingly, this analysis may be used to remove slides that are not presented for very long, or emphasize slides that are identified as being important. In another embodiment, processor 180 analyzes the report in order to ensure compliance with a protocol for the presentation. Processor 180 may analyze the report to ensure that slides that are required to be presented were presented, or that all topics were appropriately addressed (e.g., for an appropriate length of time).

For still another example, it may be desirable to keep track of documents or other objects that are distributed to the audience during the presentation. Accordingly, method 200 may include tracking objects distributed to the audience during or after the presentation. In an exemplary embodiment, input portion 140 includes a scanning component, or an imaging component. Accordingly, input portion 140 may be used to scan an object (e.g., a barcoded document or sample) in order to identify that the object was distributed during or after the presentation. Further, input portion 140 may be used to obtain an image of any object distributed during or after the presentation. This information may be stored in memory portion 160 in association with the presentation, to enable the presenter to keep track of the objects that were distributed to the audience during the presentation.

For yet another example, it may be desirable to change the order or content of the presentation during the presentation (e.g., based on feedback received from the audience). Accordingly, method 200 may include modifying the one or more images displayed during step 210. In an exemplary embodiment, during step 210, presenter may identify additional information for presentation that is not originally a part of the presentation. The presenter may then be able to add one or more supplemental images to the group of images to be displayed during step 210. The one or more supplemental images may be previously prepared, such that they may be added merely by accessing the one or more images during the presentation.

In an exemplary embodiment, display system 100 may be used to give a financial presentation on financial products such as mutual fund offerings to financial advisors. Display system 100 may display presentation media on various fund offerings with one or more slides referencing documents, e.g., via a hyperlink during the presentation. Display system 100 may capture the time these referenced documents are reviewed in order to save information on a particular financial offering.

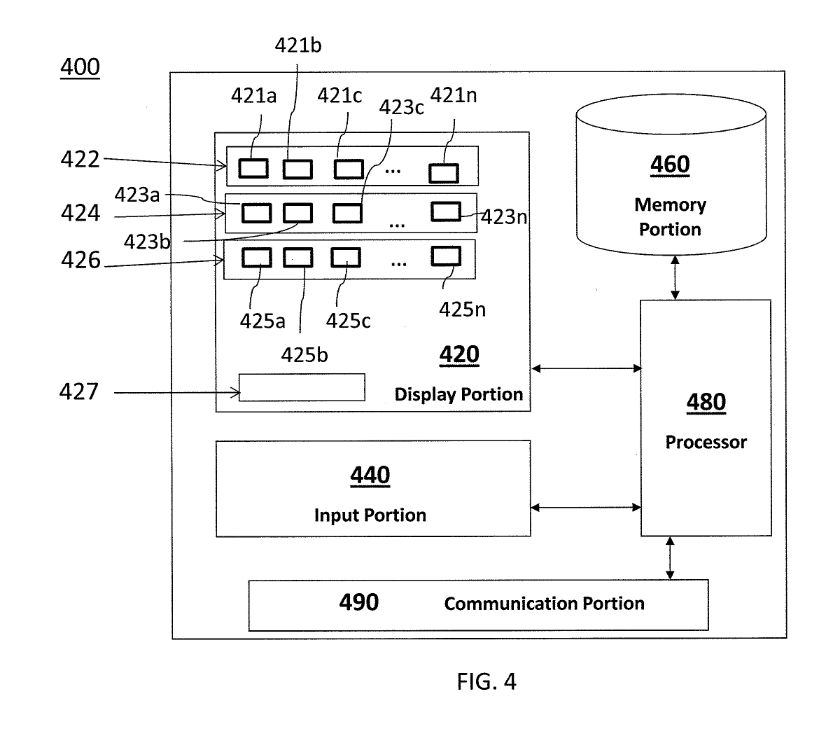

FIG. 4 illustrates a task management system 400 in accordance with aspects of the present invention. System 400 may be used to generate tasks and, optionally, to transmit the tasks to one or more designees. System 400 may be a portable electronic system such as, for example, a personal digital assistant (PDA) or a tablet computer (e.g., an iPad, available from Apple Inc. of Cupertino, Calif., USA); system 400 may also be usable in conjunction with such devices. As a general overview, system 400 includes a display portion 420, an input portion 440, a memory portion 460, one or more processors 480, and, optionally, a communication portion 490. Additional details of system 400 are described herein.

Display portion 420 visually presents information to a user. In one embodiment, display portion 420 is used to present icons related to different aspects of a task for selection to enable quick and easy generation of a task. For example, as illustrated in FIG. 4, a plurality of icons (such as icons 421a-n, 423a-n, and 425a-n) may be presented by display portion 420. The icons may be grouped by aspects of a task, e.g., who, what, when, etc. A first plurality of icons 421 may correspond to a first aspect 422 (such as who is to perform the task), a second plurality of icons 423 may correspond to a second task aspect 424 (such as what the task entails), and a third plurality of icons 425 may correspond to a third task aspect 426 (such as when the task is to be performed).

Although three task aspects 422/424/426 are illustrated, it is to be understood that there may be more or fewer task aspects. For example, display portion 420 may present additional task aspects, such as task aspect 427. Task aspect 427 may be presented as a text box to receive information not collectable by icons (e.g., “other” information). Further description of the presentation of task aspects is provided below. Furthermore, although the illustrated icons 421/423/425 are depicted as selectable buttons, it is to be understood that the icons may take other forms, such as selectable text, radio buttons, or essentially any way that enables easy selection (e.g., using a mouse click or a finger tap).

Display portion 420 may be in communication with other components of system 400 via conventional wired or wireless connections. Display portion 420 may be connected to or physically separate from the rest of the components of system 400. In an exemplary embodiment, display portion 420 is an electronic display such as, for example, a liquid crystal display (LCD). Other suitable components for use as display portion 420 will be known to one of ordinary skill in the art from the description herein.

Input portion 440 enables the receipt of information from the user of system 400. Input portion 440 further transmits the received information to processor 480 for use in system 400. In one embodiment, display portion 420 may comprise a touch screen (in addition to or in place of any other display components). In this embodiment, the touch screen may also be configured to function as input portion 440. In an alternative embodiment, input portion 440 may be a separate component configured to receive input from a user. For example, input portion 440 may be a keypad, touchpad, mouse, button, or any other conventional input device. Suitable components for use as input portion 440 will be understood by one of ordinary skill in the art from the description herein.

Memory portion 460 stores data for system 400. For example, memory portion 460 stores data comprising task information generated by system 400. Memory portion 460 may further store data comprising a generated task, which may include the information corresponding to the generated task as well as an organization and layout of that information selected by the user. Suitable memory components for use as memory portion 460 will be known to one of ordinary skill in the art from the description herein.

Communication portion 490 enables system 400 to transmit the generated task to one or more designees. Communication portion 490 may transmit the generated task to a designee via wired means. Alternatively, communication portion 490 may transmit the generated task to the designee wirelessly. Suitable components for use as communication portion 490 will be understood by one of ordinary skill in the art from the description herein.

Processor portion 480 controls the operation of system 400. Processor 480 is operable to control the information displayed on display portion 420. Processor 480 is further operable to store and access data in memory portion 460, and may control the information transmitted by communication portion 490. Suitable components for use as processor portion 480 will be understood by one of ordinary skill in the art from the description herein.

It will be understood that system 400 is not limited to the above components, but may include alternative components and additional components, as would be understood by one of ordinary skill in the art from the description herein. For example, processor 480 may include multiple processors, e.g., a first processor for controlling information displayed on display portion 420 and a second processor for controlling storage and access of data in memory portion 460. Additionally, processor portion 480 may be local, as illustrated, or partially/fully remote with one or more functions performed remotely with communication taking place over a network such as the Internet.

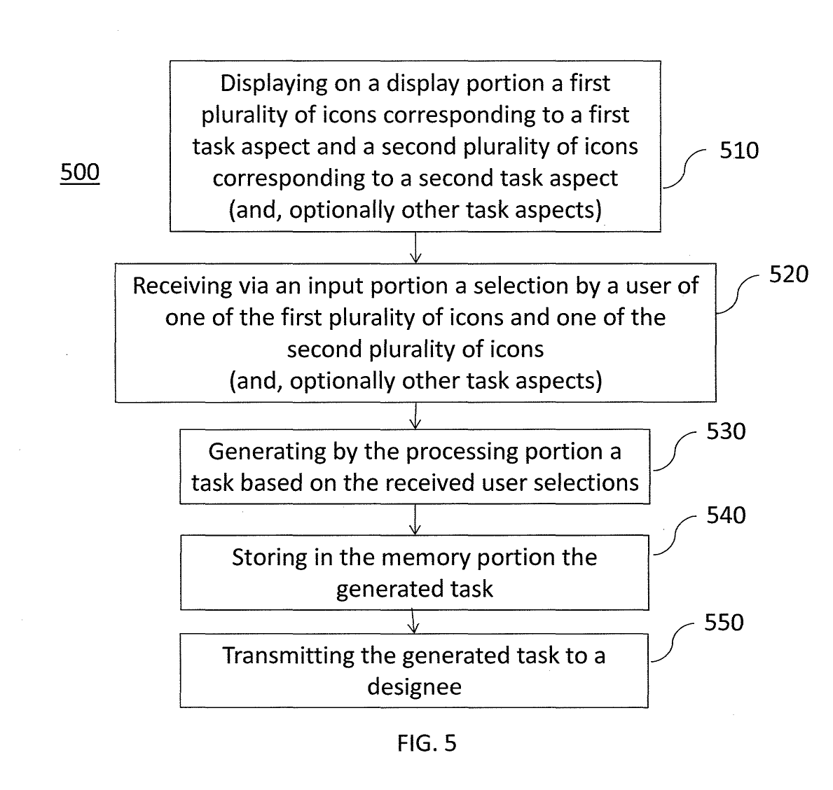

FIG. 5 depicts a flowchart 500 including steps for generating a task in accordance with aspects of the present invention. One or more of the steps in flow chart 500 may be implemented on a task management system such as system 400. Other suitable systems for implementing the flow chart will be understood by one of skill in the art from the description herein.

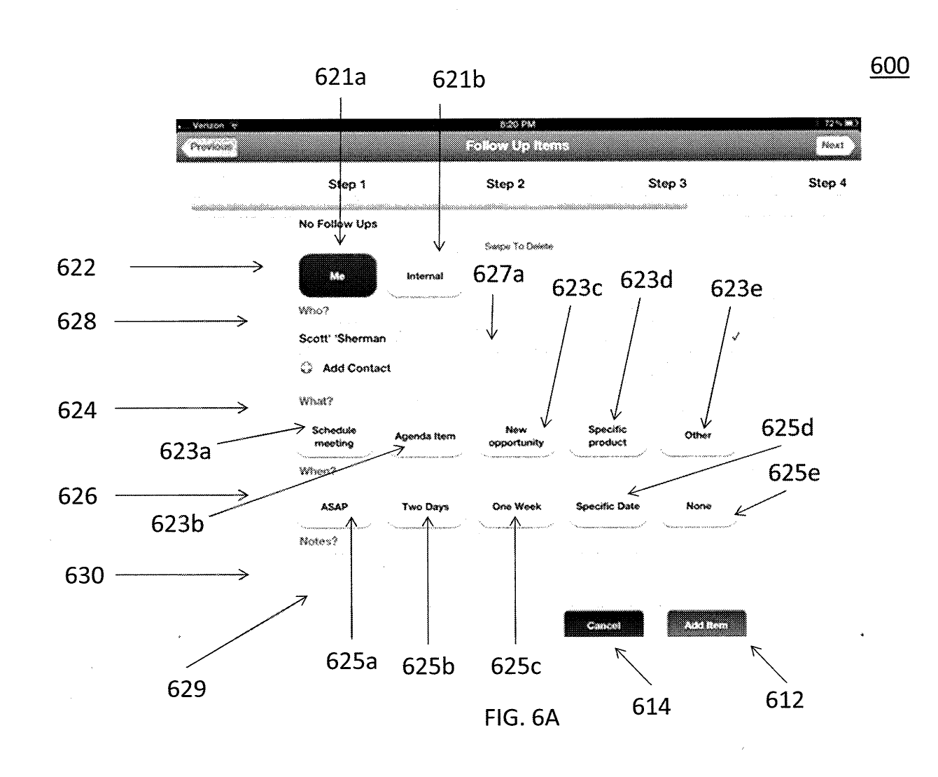

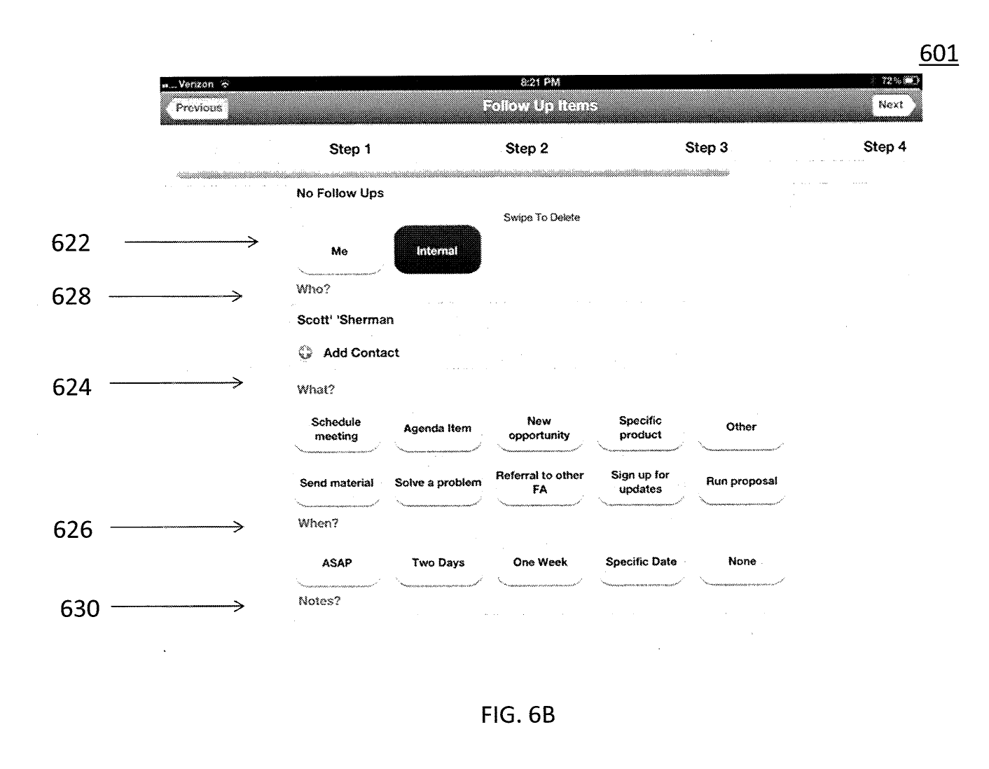

In step 510, a first plurality of icons corresponding to a first task aspect and a second plurality of icons corresponding to a second task aspect are displayed. It will be understood that additional icons corresponding to one or more additional task aspects may also be displayed. In one embodiment, processor 480 displays the plurality of icons on display portion 420. As depicted in FIG. 6A, the display portion 420 may present the icons using a graphical user interface (GUI) 600. The GUI 600 may include a plurality of icons 621a, b, 623a-e, 625a-e, and 627a.

Icons 621a, b correspond to a first task aspect 622. The first task aspect 622 designates the owner of the task (e.g., who will be responsible for the task). An owner of the task may be the sole person responsible for performing the task. Alternatively, multiple persons may be responsible for performing the task. Icon 621a, presented as a selectable button with the text “Me,” corresponds to one potential owner of the task. For example, icon 621a corresponding to task aspect 622 may signify that the originator of the task will be the owner of the task. Additional icons corresponding to task aspect 622 may be displayed on GUI 600. For example, icon 621b, presented as a selectable button with the text “Internal,” also corresponds to task aspect 622. Icon 621b may be used to assign ownership of the task to another person. Although not illustrated on GUI 600, icons within the first task aspect 622 may represent other users/groups of users who are different (or who are in addition) to those displayed.

Icons 623a-e correspond to a second task aspect 624. Second task aspect 624 designates what the task being generated entails. In one example, the second task aspect 624 may include icon 623a, presented as a selectable button that recites “Schedule meeting.” The task being generated will entail scheduling a meeting when this icon is selected. As another example, icon 623b may recite “Agenda Item.” The task being generated will entail creating an agenda item when this icon is selected.

As depicted in FIGS. 6A and 6B, the presentation of icons corresponding to task aspects may differ as a result of icon selection(s). For example, icons corresponding to the second task aspect 624 may be presented differently depending on which icon is selected from the first aspect 622. As one example, FIG. 6B depicts GUI 601 displaying ten icons corresponding to second task aspect 624. In this example, ten icons corresponding to the second task aspect 624 are displayed when selectable button 621b (e.g., “Internal”) of first task aspect 622 is selected. This differs from GUI 600, depicted in FIG. 6A, which displays five icons corresponding to second task aspect 624 being displayed when selectable button 621a (e.g., “Me”) is selected. The variation of displayed icons, however, is not limited to icons of second task aspect and icons of first task aspect 622. Icons of any task aspect may be displayed differently as a result of the selection of icons from any task aspect.

Icons 625a-e correspond to a third task aspect 626, which designates when the task being generated is to be performed. In one embodiment, icon 625a is a selectable button that recites “ASAP” and corresponds to the third task aspect 626. Icon 625a, therefore, indicates that the task be performed as soon as possible. Icon 625b is a selectable button reciting “Two Days.” Whereas the icon 625a indicates the task should be performed as soon as possible, the icon 625b indicates the task should be performed within two days.

A fourth task aspect 628 is presented by GUI 600. The fourth task aspect 628 relates to persons or entities who have a relationship with the generated task. For example, information 627a relating to the fourth task aspect 628 includes the text “Scott Sherman.” Here, “Scott Sherman” is presented as someone who has a relationship to the generated task. Mr. Sherman, for example, may be a person who should be invited to a scheduled meeting. Additional (or fewer) persons may also be presented on GUI 600.

GUI 600 may also include a text box 629 corresponding to a fifth task aspect 630. The text box 629 corresponding to fifth task aspect 630 may designate an area relating to “Other” information. In particular, the fifth task aspect 630 may include an area for information not provided by other task aspects 622/624/626/628. In one embodiment, the fifth task aspect 630 may include a blank text box 629. In that embodiment, information not provided by other task aspects may be provided in text box 629.

In step 520, a selection by a user of one of the first plurality of icons and one of the second plurality of icons is received. It will be understood that one or more additional icons corresponding to one or more additional task aspects may also be selected. The user's selections may be received via the input portion 440 and/or via the display portion 420. FIG. 6A depicts a plurality of user selectable icons 621a-621b, 623a-623e, 625a-625e, and 627a for selection by a user, which may be displayed by display portion 420. In one embodiment, where the display portion 420 functions as input portion 420, a user may select one or more of the icons by touching the respective icons. For example, a user may select icon 621a of first task aspect 622 by touching the icon with the user's finger. In other embodiments, where a separate input portion 440 is used, the user may select the one or more icons by means other than touching the icon with a finger. For example, in other embodiments, a user may click on an icon using an external peripheral device (e.g., a “mouse”), and/or may select an icon using voice commands. Suitable methods to select icons will be understood by one of ordinary skill in the art from the description herein.

A user may select one icon from each respective task aspect 622/624/626/628. For example, a user can select icon 621a from first task aspect 622, icon 623d from second task aspect 624, icon 625b from third task aspect 626, and icon 627a from fourth task aspect 628. Alternatively, a user can select icons from less than all task aspects. Thus, a user can select icons, for example, from first task aspect 622, second task aspect 624, and fourth task aspect 628, but not select an icon from the third task aspect 626. In yet another embodiment, a user could select more than one icon from each respective task aspect. Further, in one embodiment, the appearance of a selected icon may change after it is selected. The color of an icon corresponding to first task aspect 622, for example, may change after the icon has been selected by a user. In that embodiment, other selected icons corresponding to different task aspects may change to colors similar to the icons of first task aspect 622, or they may change to colors that are different from icons of first task aspect 622.

The fifth task aspect 630 is illustrated as text box 629. In one embodiment, a user may input text into the text box 629. The user may input text into text box 629 in many ways. In one embodiment, for example, the user may utilize a virtual keypad to input text into text box 629. In such an embodiment, the GUI 600 would visually present a keypad upon the display portion 420. Using keys located within the virtual keypad, the user may selectively choose the keys desired to input text into the text box 629. In another embodiment, a user may input text using a peripheral device (e.g., an external keyboard). Other embodiments for inputting text into text box 629 include a pen device (e.g., a stylus), as well as voice commands. Suitable methods to input text into text box 629 will be understood by one of ordinary skill in the art from the description herein.

In one embodiment, the processor portion 480 may count the number of times one or more icons corresponding to a task aspect have been selected by a user. For example, processor may count the number of times each icon from the second task aspect 624 have been selected, e.g., the number of times icon 623a, relating to a selectable button reciting “Schedule meeting,” is selected.

Processor may additionally associate icons selected within one task aspect with the selection count of icons from one or more task aspects. In one embodiment, for example, processor may count the number of times each icon within second task aspect 624 has been selected along with the selection of a particular icon corresponding to first task aspect 622. For example, processor may count the number of times icons 623a-e have been selected along with the selection of icon 621a of first task aspect. In another example, processor may count the number of times each icon within second task aspect 624 have been selected along with selectable button 621b reciting “Internal” of first task aspect. In one embodiment, processor may perform operations for controlling the display of icons according to the number of times the respective icons were selected by a particular user.

As will be understood by one having ordinary skill in the art, assigning tasks often results in a minority of tasks being assigned a majority of the time. A user, for example, may assign ten tasks. Out of those ten tasks, the user may select two tasks eighty percent of the time. The eight remaining assigned tasks may be selected a combined fifteen percent of the time, and undefined tasks may be assigned the remaining five percent of the time. Tasks assignments, therefore, are often highly repeatable. For example, in many businesses a “Schedule meeting” task will be assigned much more frequently than a “Run annual report” task.

Based on the principle that a small percentage of tasks will be assigned disproportionately, tasks may be predefined and arranged for convenience to the user using aspects of the present invention. In one embodiment of the present invention, tasks may be predefined as user selectable buttons. Thus, a user may create a button that represents a predefined task to be selected at a later time. Rather than having to repeatedly input and define a common task (e.g., Schedule a meeting), the user can singularly create a user selectable button representing the task, and thereafter simply select the predefined button whenever the task has to be assigned. Buttons representing the most assigned tasks are created, and buttons representing the least used tasks are removed or deemphasized. As a result, the display portion 420 of system 400 will not be cluttered with tasks that are irrelevant to a particular task originator. Further, having only the most relevant tasks presented will reduce user errors because the chance of selecting an incorrect task will be minimalized. Also, task selection is easier and quicker because only necessary tasks are presented to the user by display portion 420.

In one embodiment, system 400 may display the user selectable buttons in order from the most selected to the least selected. Ordering of tasks in this way will further result in improved convenience to the user assigning tasks because the task(s) most likely to be assigned will be the easiest task(s) to locate. Conversely, system 400 may present selectable buttons representing tasks that are less likely to be assigned in locations on display 420 that are less accessible to the user. Additionally, system 400 may perform modifications to the presentation of the selectable buttons according to the respective priority of each task. Examples of such modification may include changing the colors or sizes of the selectable buttons, moving selectable buttons to a separate page, and/or removing the selectable buttons from the display, etc.

In step 530, a task is generated based on received user selections. In one embodiment, processor portion 480 may generate the task. Processor portion 480 may collect information (e.g., icon selections) received from input portion 440 to generate the task. In one embodiment of step 530, the generated task may be generated from information received from a user. For example, with reference to FIG. 6A, if a user selects the first task aspect 622 (i.e., the owner of the task) and the second task aspect 624 (i.e., the description of the task), the generated task may include information pertaining to the owner of the task and the description of the task.

In one embodiment, a task may be generated automatically once an icon has been selected from each of the available task aspects. In another embodiment, the user may be required to select an additional icon to generate the task. For instance, the task may be generated when icon 612, reciting “Add Item,” is selected.

In step 540, the generated task is stored. The generated task may be stored in memory portion 460. In one embodiment, the stored information may include all information relating to the generated task. For example, with respect to FIG. 6A, the information stored may include information relating to task aspects 622/624/626/628/630. Additionally, the stored information may include other information. In one embodiment, information regarding the task may be stored on a time-basis (e.g., every five minutes a user is accessing the task management system), or on an action-basis (e.g., whenever a selectable button is depressed by the user). In one embodiment, information regarding the generated task may be stored in a user's virtual calendar. The information may be stored locally with respect to the task management system, or remotely.

In step 550, the generated task is transmitted to one or more designees. In one embodiment, the generated task may be transmitted to a designee by communication portion 490. The task may be transmitted to a designee who is a user of system 400. Alternatively (or, additionally), the task may be transmitted to a designee who is not a user of system 400. In one embodiment, the generated task may be transmitted to a designee in response to the selection of icon 612 corresponding to selectable button reciting “Add Item” (FIG. 6A). In alternative embodiments, the generated task may be transmitted to a designee responsive to other activity (e.g., by closing the task management system or selecting another icon corresponding to another user selectable button).

In one embodiment, the generated task may be transmitted to a designee corresponding to any icon selected within first task aspect 622 and/or fourth task aspect 628. In one embodiment, the generated task may be transmitted to the designee via an intranet. Alternatively, the generated task may be transmitted to a designee via the Internet. In one embodiment, the generated task will be delivered to the designee's task management application. The generated task may also (or, in the alternative) be transmitted to a designee via e-mail, or other electronic messaging service. After the generated task is transmitted to a designee, an acknowledgement may be sent to the user informing the user that the task was transmitted successfully (or unsuccessfully).

In one embodiment, the designee does not have to be a user of system 400 to receive a transmitted task. In this embodiment, the transmitted task may include a notification (e.g., an email) of the task from the task originator describing the task. If the designee is not a user of system 400, the notification may optionally provide information about the task originator, a process outlining how the designee may become a member of system 400, as well as additional information that the task originator may consider relevant. In one embodiment, to become a user of system 400, the designee may download an application and register with system 400.

Alternatively, if the designee is a user of the system at the time of the task request, the designee may either accept or reject the generated task. If the designee rejects the task, a notice may be sent to the task originator informing the originator that the task has been rejected. In addition to the rejection, the notification may include, for example, information describing why the task was rejected. The notification may also include information including a proposed task which would be acceptable to the designee. The originator may then resend the prior task to the designee unchanged (with or without comments), or, alternatively, the originator could send a task to the designee incorporating the modifications as proposed. By allowing communicate between the originator and designee with respect to a proposed task, a task can be assigned that is acceptable to all parties. Thus, the present invention provides a method to delegate a task that is agreeable among all parties involved in the completion of the task.

In one embodiment, once a task is accepted, a notification (including specifics of the task) may be sent to the originator apprising the originator of the acceptance. The details of the assigned task may be stored in memory, and processor 480 may enter the time for completion of the task in a virtual calendar of all (or select) users related to the task. Inputting the task information into the users' respective virtual calendars allows users to remain apprised of the time commitment for the assigned task(s). By incorporating the task in a virtual calendar, for example, a user may realize time conflicts regarding task and/or non-task related commitments. Additionally, by incorporating the task in users' virtual calendar, the user may be notified by the virtual calendar when the deadline of the task is approaching.

The above-described exemplary methods may be performed by one or more processors executing one or more sequences of instructions for presenting information to an audience, the one or more sequences of instructions stored on a non-transient computer readable medium. Execution of the one or more sequences of instructions causes the one or more processors to perform the steps of the above-described exemplary methods. Thus, it will be understood by one of ordinary skill in the art that embodiments of the invention are not limited to any specific combination of hardware and software.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for gathering data from a presenter giving a presentation of information to an audience using a display system, the display system comprising a display portion, an input portion, a memory portion for storing the presentation, and one or more processors operable to control the information displayed on the display portion and the data stored in the memory portion, the method comprising the steps of:
displaying one or more images on the display portion, the images including the information to be presented to the audience;
receiving data from a presenter via the input portion, the received data comprising a report from the presenter on the performance of the presentation; and
storing the report in association with the presentation in the memory portion.

2. The method of claim 1, wherein the receiving step is performed after the displaying step.

3. The method of claim 2, wherein the report comprises a scheduled time for a follow-up meeting.

4. The method of claim 3, further comprising the step of:
entering the scheduled time in a virtual calendar of the presenter with the processor.

5. The method of claim 2, wherein the report comprises a record of the persons present in the audience for the presentation.

6. The method of claim 2, wherein the report comprises a rating of one or more aspects of the presentation.

7. The method of claim 6, wherein the one or more aspects of the presentation are selected from the group consisting of audience engagement, presentation of material, value of a follow-up presentation, audience reaction, audience questions, and relationship with audience.

8. The method of claim 1, wherein the receiving step is performed during the display step.

9. The method of claim 8, wherein the report comprises an indication of a portion of the presentation in which the audience had an interest.

10. The method of claim 1, further comprising:
recording the length of time of at least a portion of the presentation; and
storing the length of time in association with the presentation in the memory portion.

11. The method of claim 10, wherein the recording step comprises recording the length of time one of the one or more images is presented during the presentation.

12. The method of claim 1, further comprising:
analyzing the report.

13. A system for gathering data from a presenter giving a presentation of information to an audience, the system comprising:
a display portion,
an input portion,
a memory portion for storing the presentation, and
one or more processors operable to control the information displayed on the display portion and the data stored in the memory portion, the one or more processors operable to perform the steps of claim 1.

14. A non-transient computer readable medium comprising one or more sequences of instructions for gathering data from a presenter presenting information to an audience, wherein execution of the one or more sequences of instructions by one or more processors causes the one or more processors to perform the steps of claim 1.

15. A method for generating tasks using an electronic system, the system including a display portion, an input portion, a memory portion, and a processing portion operable to control the information displayed on the display portion, the method comprising the steps of:
displaying on the display portion a first plurality of icons corresponding to a first task aspect and a second plurality of icons corresponding to a second task aspect;
receiving via the input portion a first selection by a user of one of the first plurality of icons and a second selection by the user of one of the second plurality of icons; and
generating by the processing portion a task based on the received user selections of the one of the first plurality of icons and the one of the second plurality of icons.

16. The method of claim 15, further comprising:
storing the generated task in the memory portion.

17. The method of claim 15, wherein the first task aspect designates who is to perform the generated task and wherein the method further comprises:
transmitting the generated task via the communication portion to a designee corresponding to the selected one of the first plurality of icons.

18. The method of claim 15, wherein:
the displaying step further comprises displaying on the display portion a third plurality of icons corresponding to a third task aspect;
the receiving step further comprises receiving via the input portion a third selection by the user of one of the third plurality of icons; and
generating by the processors the task based additionally on the received user selection of the one of the third plurality of icons.

19. The method of claim 18, wherein:
the first plurality of icons correspond to who is to perform the task being generated;
the second plurality of icons correspond to what the task being generated entails; and
the third plurality of icons correspond to when the task being generated is to be performed.

20. The method of claim 15, wherein each of the first plurality of icons and each of the second plurality of icons include selectable buttons presented on the display portion.

21. The method of claim 15, wherein each of the first plurality of icons and each of the second plurality of icons include selectable text presented on the display portion.

22. The method of claim 15, wherein the second task aspect designates what the task being generated entails, the method further comprising:
determining a number of times each of the second plurality of icons have been selected; and
storing in the memory portion the determined number of times each of the second plurality of icons have been selected.

23. The method of claim 22, wherein the displaying step comprises:
displaying on the display portion the second plurality of icons in a prioritized order corresponding to the determined number of times each of the second plurality of icons have been selected.

24. The method of claim 23, wherein the icon having the lowest number of determined selections is not displayed.

25. The method of claim 15, wherein the second plurality of icons correspond to what the task being generated entails and wherein what the tasks being generated entails are predefined by a user of the system.

26. The method of claim 17, wherein the user and the designee are different.

27. The method of claim 17, wherein the user and the designee are the same.

28. The method of claim 20, wherein the selectable buttons are selected via touching the display portion of the display system.

29. The method of claim 15, wherein the method further comprises:
organizing the plurality of icons corresponding to the second aspect according to predefined categories; and
displaying the plurality of icons corresponding to the second aspect according to the predefined categories.

30. The method of claim 15, wherein the transmitting step further comprises:
transmitting the generated task to the designee via the Internet.

31. The method of claim 18, wherein the data corresponding to the first task aspect, the second task aspect, and the third task aspect is automatically entered into a virtual calendar of the user.

32. A system for gathering data from a user for generating tasks, the system comprising:
a display portion;
an input portion;
a memory portion;
a communication portion; and
one or more processors operable to control the information displayed on the display portion and the data stored in the memory portion, the one or more processors operable to perform the steps of claim 15.
